(19) United States
(12) Patent Application Publication
(10) Pub. No.: US 2011/0248127 A1
(43) Pub. Date: Oct. 13, 2011

(54) Display

(76) Inventors: Joel Moore, Lexington, MA (US); James W. Riddick, Mustang, OK (US); Jessica Moreland, Columbus, OH (US); Christopher Trunek, Auburn Township, OH (US); Joel Beebe, Columbus, OH (US)

(21) Appl. No.: 13/082,188

(22) Filed: Apr. 7, 2011

Related U.S. Application Data
(60) Provisional application No. 61/321,756, filed on Apr. 7, 2010.

(51) Int. Cl. F16M 11/04; H01F 7/02

(52) U.S. Cl. 248/121

(57) ABSTRACT

Devices are disclosed having a magnet disposed thereon, operatively configured for retaining a ferrous element thereagainst.

### CLAIM OF PRIORITY

This application claims priority to provisional patent application No. 61/321,756 filed on Apr. 7, 2010 which is incorporated by reference herein in its entirety.

### BACKGROUND AND FIELD

Numerous articles, including tags, signage, clothing, and baseball caps contain ferric elements which may be attracted by magnets. Devices are disclosed for suspending such articles herein.

### SUMMARY

According to embodiments of the present disclosure described herein, a display includes; a base portion having at least one contact point with a floor at a ventral end thereof and coupled to a beam at the dorsal end thereof; the beam comprising an elongated, narrow, substantially vertical member coupled to a ventral-facing magnet at the dorsal end thereof; the ventral-facing magnet sized and shaped to magnetically retain the ferrous pin disposed at the apex of a cap or other article thereagainst.

According to further embodiments of the present disclosure described herein, there is a substantially planar member disposed between the beam and magnet, having substantially chiral, sloping sides at an obtuse angle to one another which opens ventrally with the sides meeting at a point at the dorsal apex thereof thereby allowing a garment to be hung thereon.

According to further embodiments of the present disclosure described herein, the magnet is disposed at the dorsal apex of the inner circumference of a substantially planar annulus.

According to further embodiments of the present disclosure described herein, is a plurality of annulae in a substantially co-planar relation to one another.

According to further embodiments of the present disclosure described herein, the magnet is disposed within a substantially annular projection which extends ventrally from the magnet and is sized and shaped to retain the apex pin of a cap therein.

According to further embodiments of the present disclosure described herein, the magnet is disposed in a recess, the recess being sized and shaped to retain the apex pin of a cap therein.

According to certain embodiments of the present disclosure described herein, a display includes a body comprising a rigid volume having a posterior face and a ventral face, with the posterior face being substantially planar and operatively configured to be coupled to a stationary object, including for instance a wall; a ventral-facing magnet disposed upon the ventral face of the body sized and shaped to magnetically retain the ferrous pin disposed at the apex of a cap or other article thereagainst.

According to further embodiments of the present disclosure described herein, the body is coupled to a stationary object by one of the following; a bracket disposed on the body and mountable to the object, a bracket disposed on the object and mountable to the body, screws, nails, adhesive, snap fittings or other coupling means known in the arts.

According to further embodiments of the present disclosure described herein, the body has substantially parallel ventral and dorsal faces, thereby defining a shelf.

According to further embodiments of the present disclosure described herein, the magnet is disposed within a substantially annular projection which extends ventrally from the magnet and is sized and shaped to retain the apex pin of a cap therein.

According to further embodiments of the present disclosure described herein, the magnet is disposed in a recess, the recess being sized and shaped to retain the apex pin of a cap therein.

According to further embodiments of the present disclosure described herein, there is a plurality of magnets.

According to further embodiments of the present disclosure described herein, the anterior face of the body has a portion of transparent polymer affixed thereto and operatively configured for retaining a tag therein.

According to further embodiments of the present disclosure described herein, the body is an elongated member having a substantially C-shaped cross-section which opens posteriorly.

According to further embodiments of the present disclosure described herein, the body is an elongated member having a substantially c-shaped cross-section which opens anteriorly.

According to certain embodiments of the present disclosure described herein, a display includes a folded, thin, rigid armature whose profile approximates a C-shape, the armature having a wide, substantially planar ventral end portion defining a foot, a substantially vertical portion defining a neck, and a substantially horizontal dorsal portion defining a head; a ventral-facing magnet disposed upon the ventral face of the head sized and shaped to magnetically retain the ferrous pin disposed at the apex of a cap or other article thereagainst.

According to further embodiments of the present disclosure described herein, there is a longitudinal portion removed from the foot, neck, and head, thereby defining a channel therethrough.

According to further embodiments of the present disclosure described herein, the magnet is disposed within a substantially annular projection which extends ventrally from the magnet and is sized and shaped to retain the apex pin of a cap therein.

According to further embodiments of the present disclosure described herein, the magnet is disposed in a recess, the recess being sized and shaped to retain the apex pin of a cap therein.

According to further embodiments of the present disclosure described herein, there is a plurality of magnets.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows an isometric view of a first exemplary embodiment of the present disclosure.

FIG. 2 shows an isometric view of a second exemplary embodiment of the present disclosure.

FIG. 3 shows an isometric view of a third exemplary embodiment of the present disclosure.

FIG. 4 shows an isometric view of a fourth exemplary embodiment of the present disclosure.

FIG. 5 shows an isometric view of a fifth exemplary embodiment of the present disclosure.

FIG. 6 shows an isometric front view of a sixth exemplary embodiment of the present disclosure.

FIG. 7 shows an isometric rear view of the sixth exemplary embodiment of the present disclosure.

FIG. 8 shows an isometric view of an seventh exemplary embodiment of the present disclosure.

FIG. 9 shows an isometric view of a eighth exemplary embodiment of the present disclosure.

FIG. 10 shows an isometric view of a ninth exemplary embodiment of the present disclosure.

### DETAILED DESCRIPTION OF THE FIGURES

Various embodiments of the presently disclosed apparatus will now be described in detail with reference to the drawings, wherein like reference numerals identify similar or identical elements. Various anatomical terms of location, namely anterior, posterior, ventral, dorsal, medial, and lateral shall have their ordinary spacial meanings in the arts.

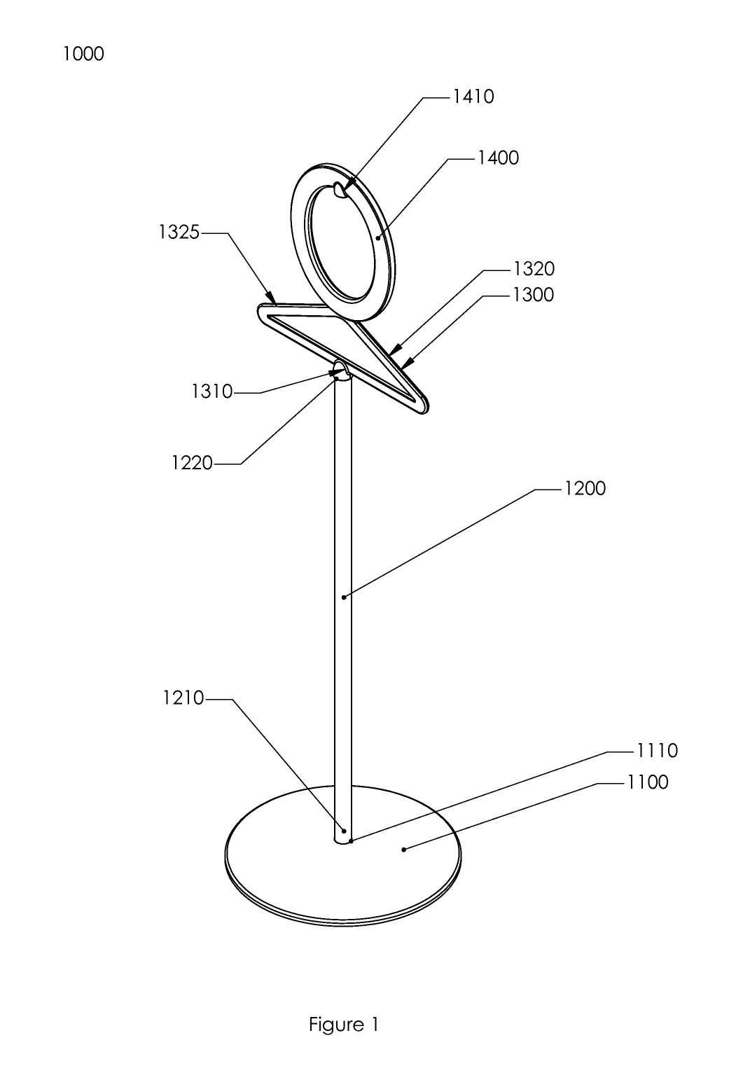

With reference to FIG. 1, a first embodiment of a hat rack is shown. Hat rack 1000 has a base 1100, a support 1200, a shoulder 1300, an annulus 1400, and a hat coupler 1410. Base 1100 is a substantially planar, discal member composed of substantially rigid material, including for instance a natural or synthetic resin or polymer, or a metal. According to further embodiments of the present disclosure not shown in the figures, Base 1100 may further comprise an anchor weight portion made from a metal, sand, concrete, or other relatively dense material and molded, screwed, or adhered to the base, wherein the anchor weight portion lowers the center of gravity and consequently stabilizes the assembled device. Although the embodiment of the present disclosure shown in the figures shows a circular and planar base member, there are further embodiments of the present disclosure wherein contact with a floor may be achieved by means of a non-planar and non-discal member, including for instance, a tripod, domed foot, or other foot structure known in the arts.

There is an aperture 1100 disposed centrally upon the dorsal face of base 1100, and operatively configured to receive and retain a complementary fitting 1210 of support 1200 therein. Although the assembly as shown in FIG. 1 is fitted by way of press-fitting, there are further embodiments of the present disclosure not shown in the figures wherein base 1100 and support 1200 are coupled by means of complimentary bayonet mounts, threads, adhesives, and other rigid coupling means known in the art. Although aperture 1110 is shown in the figures disposed centrally within base 1100, there are further embodiments of the present disclosure wherein aperture 1110 is oriented eccentrically within base 1100.

With continued reference to FIG. 1, support 1200 is a rigid elongated member have a substantially circular cross section composed substantially of a metal, natural polymer, or synthetic polymer. There are further embodiments of the present disclosure wherein the cross section of support 1200 approximates an annulus, a polygon having up to twenty sides, or combination thereof. At the topmost portion of support 1200, there is a fitting 1220 configured to be press fit within a receiver 1310 disposed upon shoulder 1300. Although the assembly as shown in FIG. 1 is fitted by way of press-fitting, there are further embodiments of the present disclosure not shown in the figures wherein support 1200 and shoulder 1300 are coupled by means of complimentary bayonet mounts, threads, adhesives, and other rigid coupling means known in the art.

Shoulder 1300 is a rigid member having slanted sides 1320 and 1325 extending in an obtuse angle away from a center point 1340 disposed dorsally and opening away from one another ventrally. The ventral portion of sides 1325 and 1325 is joined by a crossbar 1330. Crossbar 1330 is coupled to receiver 1310.

There is an annulus 1400 coupled to shoulder 1300 near center point 1340. Annulus 1400 is a rigid, substantially annular, substantially discal member having a hat coupler 1410 disposed upon the dorsal end portion of the inner circumference thereof. Hat coupler 1410 comprises a magnetically active material configured to receive and retain the ferrous center pin of a hat or cap thereon. The magnetically active material of hat coupler 1410 may be a permanent magnet, a temporary magnet, or an electromagnet.

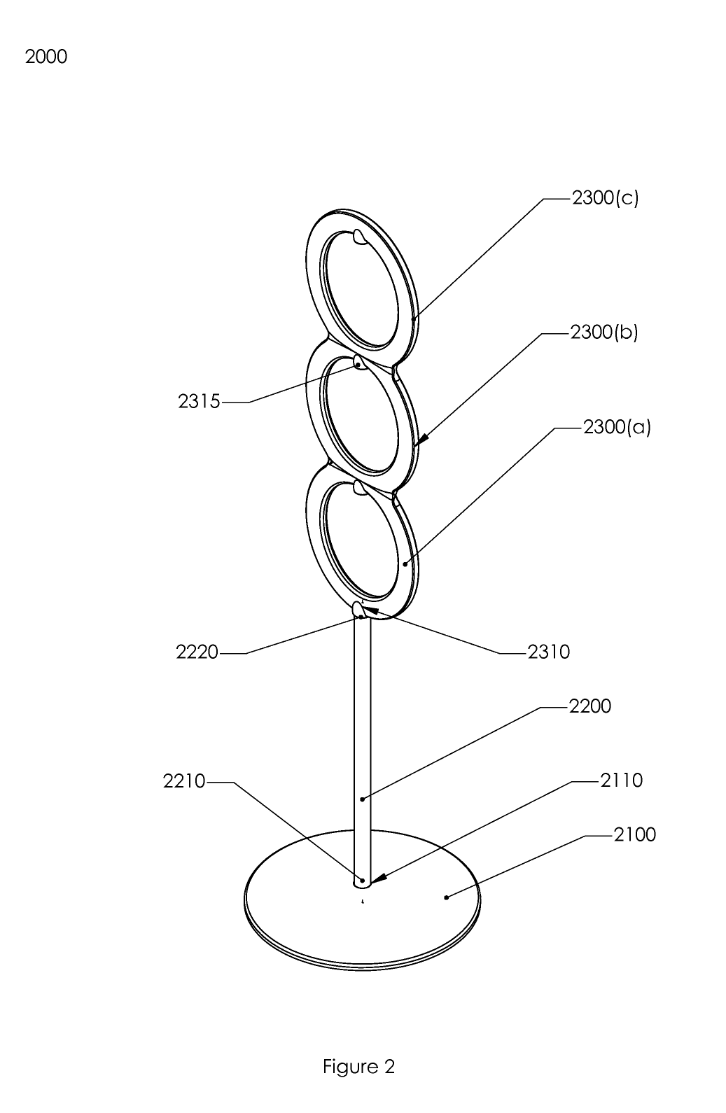

Referring now to FIG. 2, an embodiment of a hat rack is shown. Hat rack 2000 has a base 2100, a support 2200, and annulae 2300(a-c). Base 2100 is a substantially planar, discal member composed of substantially rigid material, including for instance a natural or synthetic resin or polymer, or a metal. According to further embodiments of the present disclosure not shown in the figures, Base 2100 may further comprise an anchor weight portion made from a metal, sand, concrete, or other relatively dense material and molded, screwed, or adhered to the base, wherein the anchor weight portion lowers the center of gravity and consequently stabilizes the assembled device. Although the embodiment of the present disclosure shown in the figures shows a circular and planar base member, there are further embodiments of the present disclosure wherein contact with a floor may be achieved by means of a non-planar and non-discal member, including for instance, a tripod, domed foot, or other foot structure known in the arts.

There is an aperture 2100 disposed centrally upon the dorsal face of base 2100, and operatively configured to receive and retain a complementary fitting 2210 of support 2200 therein. Although the assembly as shown in FIG. 2 is fitted by way of press-fitting, there are further embodiments of the present disclosure not shown in the figures wherein base 2100 and support 2200 are coupled by means of complimentary bayonet mounts, threads, adhesives, and other rigid coupling means known in the art. Although aperture 2110 is shown in the figures disposed centrally within base 1100, there are further embodiments of the present disclosure wherein aperture 1110 is oriented eccentrically within base 2100.

With continued reference to FIG. 2, support 2200 is a rigid elongated member have a substantially circular cross section composed substantially of a metal, natural polymer, or synthetic polymer. There are further embodiments of the present disclosure wherein the cross section of support 2200 approximates an annulus, a polygon having up to twenty sides, or combination thereof. At the topmost portion of support 2200, there is a fitting 2220 configured to be press fit within a receiver 2310 disposed upon annulus 2300(a). Although the assembly as shown in FIG. 2 is fitted by way of press-fitting, there are further embodiments of the present disclosure not shown in the figures wherein support 2200 and annulus 2300(a) are coupled by means of complimentary bayonet mounts, threads, adhesives, and other rigid coupling means known in the art.

There are annulae 2300(a-c) coupled to support 2300. Annulae 2300(a-c) are rigid, substantially annular, substantially discal members having a hat coupler 2315 disposed upon the dorsal end portion of the inner circumference thereof. Hat coupler 2315 comprises a magnetically active material configured to receive and retain the ferrous center pin of a hat or cap thereon. The magnetically active material of hat coupler 2315 may be a permanent magnet, a temporary magnet, or an electromagnet.

With continued reference to FIG. 2, annulae 2300(a-c) comprise a single, molded member. There are further embodiments of the present disclosure however wherein annulae 2300(a-c) are distinct members and coupleable to one another by way of press-fitting, snap-fitting, complimentary bayonet mounts, threads, adhesives, and other rigid coupling means known in the art.

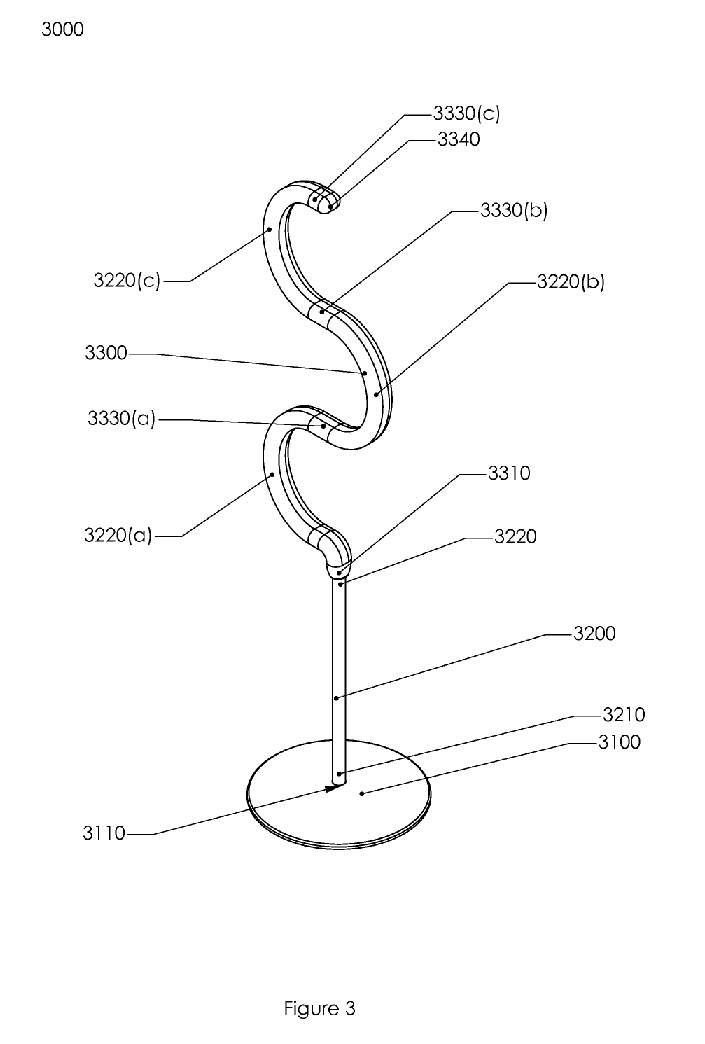

Referring now to FIG. 3, an embodiment of a hat rack is shown. Hat rack 3000 has a base 3100, a support 3200, and s-curve 3300. Base 3100 is a substantially planar, discal member composed of substantially rigid material, including for instance a natural or synthetic resin or polymer, or a metal. According to further embodiments of the present disclosure not shown in the figures, Base 3100 may further comprise an anchor weight portion made from a metal, sand, concrete, or other relatively dense material and molded, screwed, or adhered to the base, wherein the anchor weight portion lowers the center of gravity and consequently stabilizes the assembled device. Although the embodiment of the present disclosure shown in the figures shows a circular and planar base member, there are further embodiments of the present disclosure wherein contact with a floor may be achieved by means of a non-planar and non-discal member, including for instance, a tripod, domed foot, or other foot structure known in the arts.

There is an aperture 3110 disposed centrally upon the dorsal face of base 3100, and operatively configured to receive and retain a complementary fitting 3210 of support 3200 therein. Although the assembly as shown in FIG. 3 is fitted by way of press-fitting, there are further embodiments of the present disclosure not shown in the figures wherein base 3100 and support 3200 are coupled by means of complimentary bayonet mounts, threads, adhesives, and other rigid coupling means known in the art. Although aperture 3110 is shown in the figures disposed centrally within base 3100, there are further embodiments of the present disclosure wherein aperture 3110 is oriented eccentrically within base 3100.

With continued reference to FIG. 3, support 3200 is a rigid elongated member have a substantially circular cross section composed substantially of a metal, natural polymer, or synthetic polymer. There are further embodiments of the present disclosure wherein the cross section of support 3200 approximates an annulus, a polygon having up to twenty sides, or combination thereof. At the topmost portion of support 3200, there is a fitting 3220 configured to be press fit within a receiver 3310 disposed upon the s-curve 3300. Although the assembly as shown in FIG. 3 is fitted by way of press-fitting, there are further embodiments of the present disclosure not shown in the figures wherein support 3200 and s-curve 3300 are coupled by means of complimentary bayonet mounts, threads, adhesives, and other rigid coupling means known in the art.

Referring still to FIG. 3, and proceeding from ventral to dorsal elements, s-curve 3300 is comprised of receiver 3310, a c-curve 3320(a), coupler 3330(a), s-curve 3320(b), coupler 3330(b), c-curve 3320(c), coupler 3330(c), and end plug 3330.

C-curve 3320 is a rigid arcuate member approximating half of a circle and configured to be rigidly coupled at adjacent structures at its dorsal and ventral ends by press-fitting. Although the assembly as shown in FIG. 3 is fitted by way of press-fitting, there are further embodiments of the present disclosure not shown in the figures wherein c-curve 3330 and and its respective adjacent members are coupled by means of complimentary bayonet mounts, threads, adhesives, and other rigid coupling means known in the art.

Coupler 3330 is a rigid member having a first and second end which are both configured to be press-fit into the respective dorsal and ventral ends of a c-curve. The ventral face of coupler 3330 has a hat coupler (not visible in the figures) disposed thereupon. The hat coupler comprises a magnetically active material configured to receive and retain the ferrous center pin of a hat or cap thereon. The magnetically active material of the hat coupler may be a permanent magnet, a temporary magnet, or an electromagnet.

End cap 3340 is a domed member which is press-fit into the open end of coupler 3330(c) thereby terminating s-curve 3300.

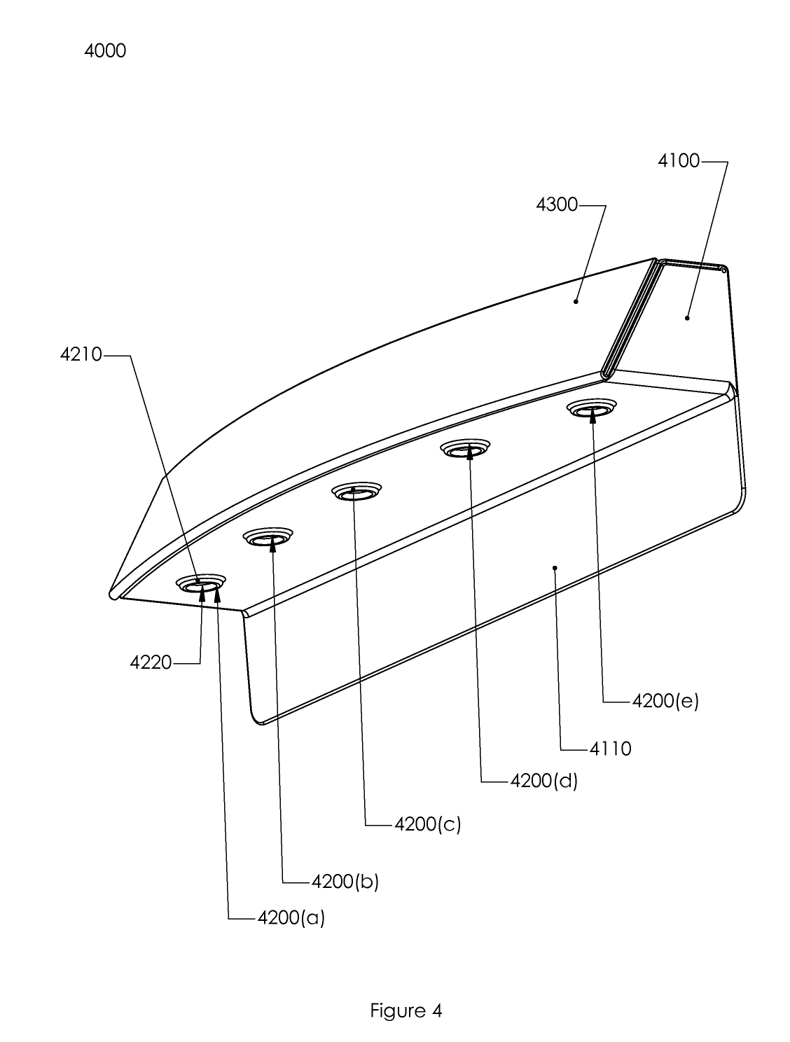

With reference to FIG. 4, a hat rack 4000 is shown having a body 4100 with a a planar face 4110 extending ventrally from the posterior portion thereof, a plurality of couplers 4200(a-e) disposed on the ventral face of body 4100, and a display 4300 disposed on the anterior face of body 4100.

Body 4100 is a rigid, elongated member having a quadrilateral cross-section and a anterior face which is arcuate and inclined dorsally. Body 4100 is composed substantially of a natural or synthetic polymer, metal, or other rigid material known in the arts. Face 4110 is a substantially planar, substantially rectangular member extending ventrally from the posterior portion of body 4100. There is a plurality of hat couplers 4200(a-e) disposed upon the ventral face of body 4100. Coupler 4200 comprises a groove 4210 and a magnet 4220. Groove 4210 is an annular member extending ventrally from the face of body 4100 and shaped to correspond to the ferrous center pin at the apex of a hat. Magnet 4220 comprises a magnetically active material disposed within the center of groove 4210 and configured to receive and retain the ferrous center pin of a hat or cap thereagainst. The magnetically active material of hat coupler 1410 may be a permanent magnet, a temporary magnet, or an electromagnet.

Display 4300 is a folded portion of transparent plastic, including for instance a polycarbonate or Lexan® molded to duplicate the curvature of the anterior face of body 4100 to which it is coupled by snap-fitting, hook-loop fastener, or adhesive. Display 4300 is configured to receive and retain signage therein.

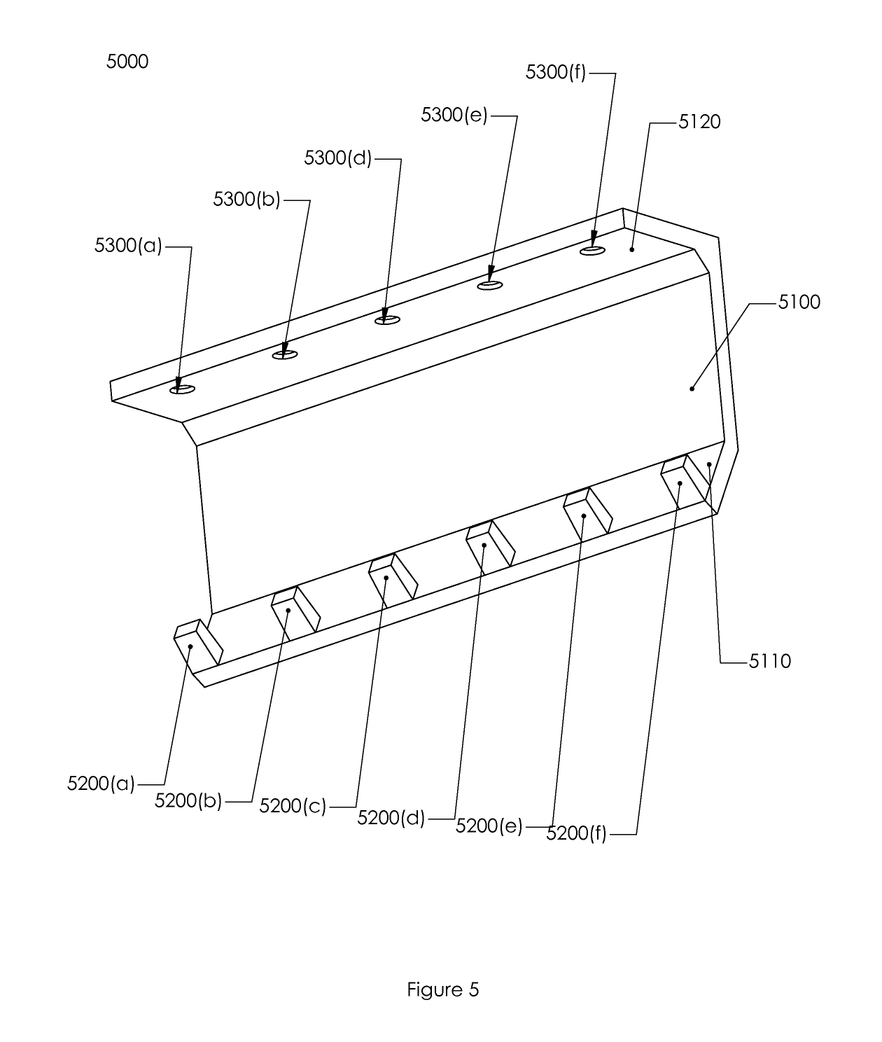

Referring now to FIG. 5, an embodiment of the present disclosure is shown. Rack 5000 comprises a body 5100, hooks 5200(a-f), and couplers 5300(a-f). Body 5100 is an elongated rigid member having a substantially c-shaped cross-section opening anteriorly. The posterior face of body 5100 is configured to be fixed to a wall by means of screws, adhesives, snap-fittings, or nails disposed therein. There is a ventral face 5110 extending at an obtuse angle from body 5100. There is a plurality of hooks 5200(a-f) extending in substantially orthogonal relation to face 5110 and shaped for the hanging of clothing thereon.

There is a dorsal shelf 5120 extending in substantially orthogonal relation from the dorsal portion of body 5100. There is a plurality of couplers 5300(a-f) disposed upon the ventral face of shelf 5120. Coupler 5300 is comprised of a magnet 5310 recessed into the surface of shelf 5120. The diameter of the recess within which coupler 5300 is disposed is defined by the shape of a ferrous pin disposed upon the apex of a hat. Magnet 5310 is a permanent magnet, a temporary magnet, or an electromagnet.

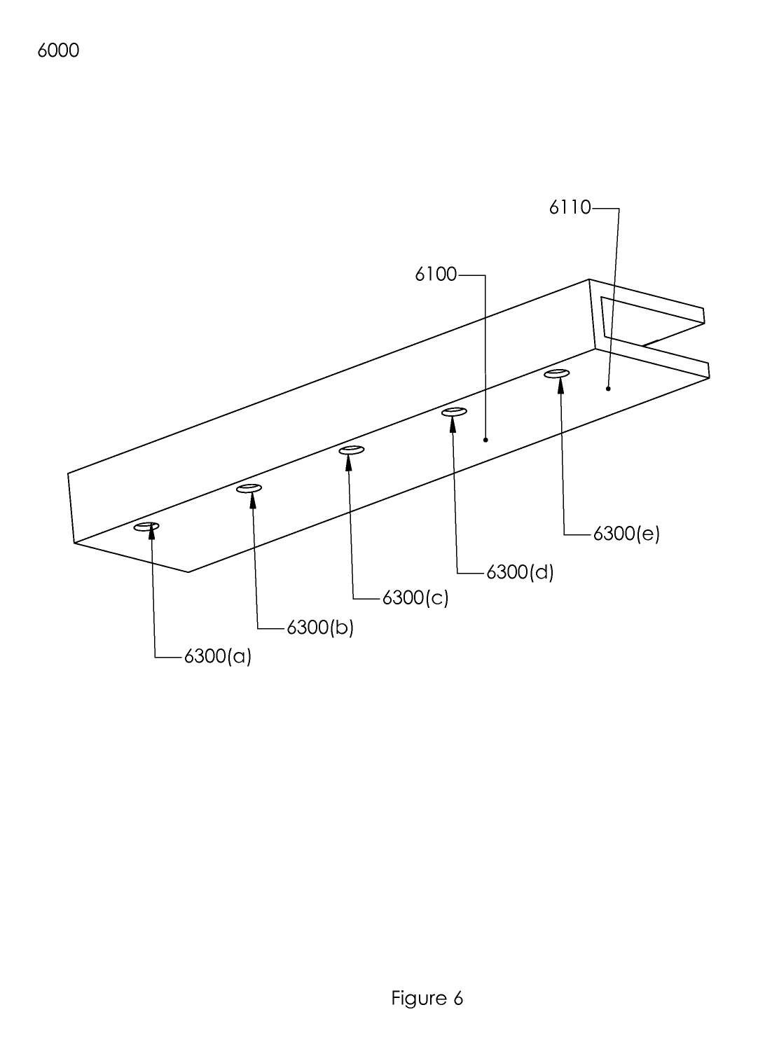

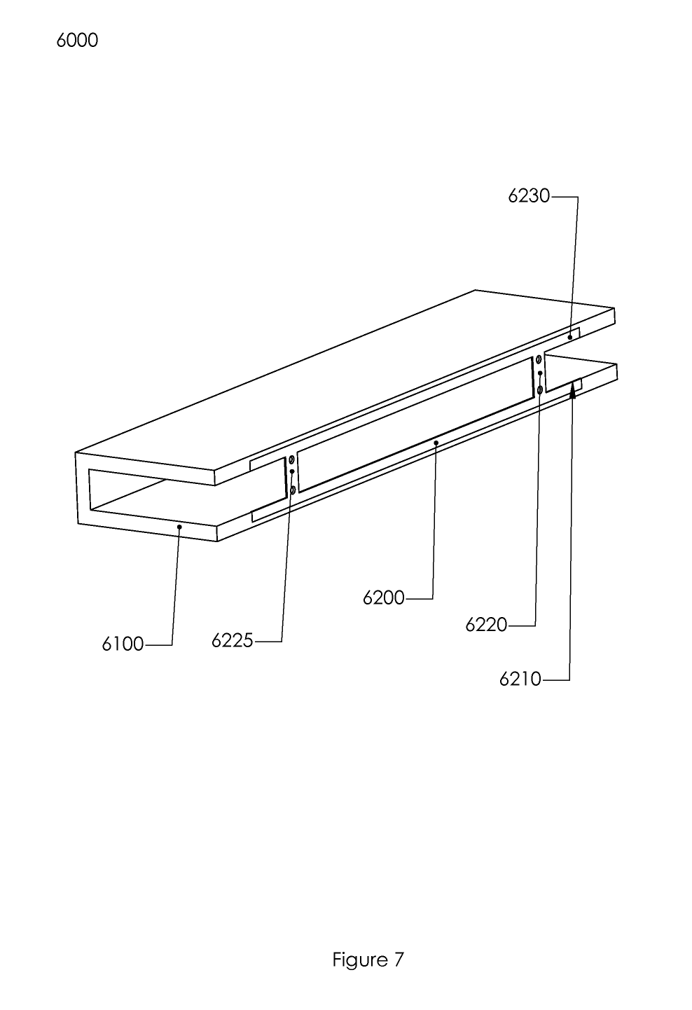

Referring now to FIGS. 6 and 7 together, an embodiment of the present disclosure is shown wherein a rack 6000 comprises a body 6100, a bracket 6200, and a plurality of couplers 6300(a-e). Body 6100 is an elongated, substantially rigid member having a substantially c-shaped cross-section opening posteriorly. Body 6100 has a ventral face 6110 having couplers 6300(a-e) disposed thereupon. Coupler 6300 comprises a magnet 6310 recessed within a bore. The diameter of the recess within which coupler 6300 is disposed is defined by the shape of a ferrous pin disposed upon the apex of a hat. Magnet 6310 is a permanent magnet, a temporary magnet, or an electromagnet.

Referring now to FIG. 7, there is a bracket 6220 having horizontal beams 6210 and 6230 coupled to the posterior face of body 6100. Further, bracket 6220 has vertical beams 6220 and 6225 oriented in substantially orthogonal relation to horizontal beams 6210 and 6230. Vertical beams 6220 and 6225 have apertures extending therethrough for coupling rack 6000 to a rigid structure, for instance, a wall.

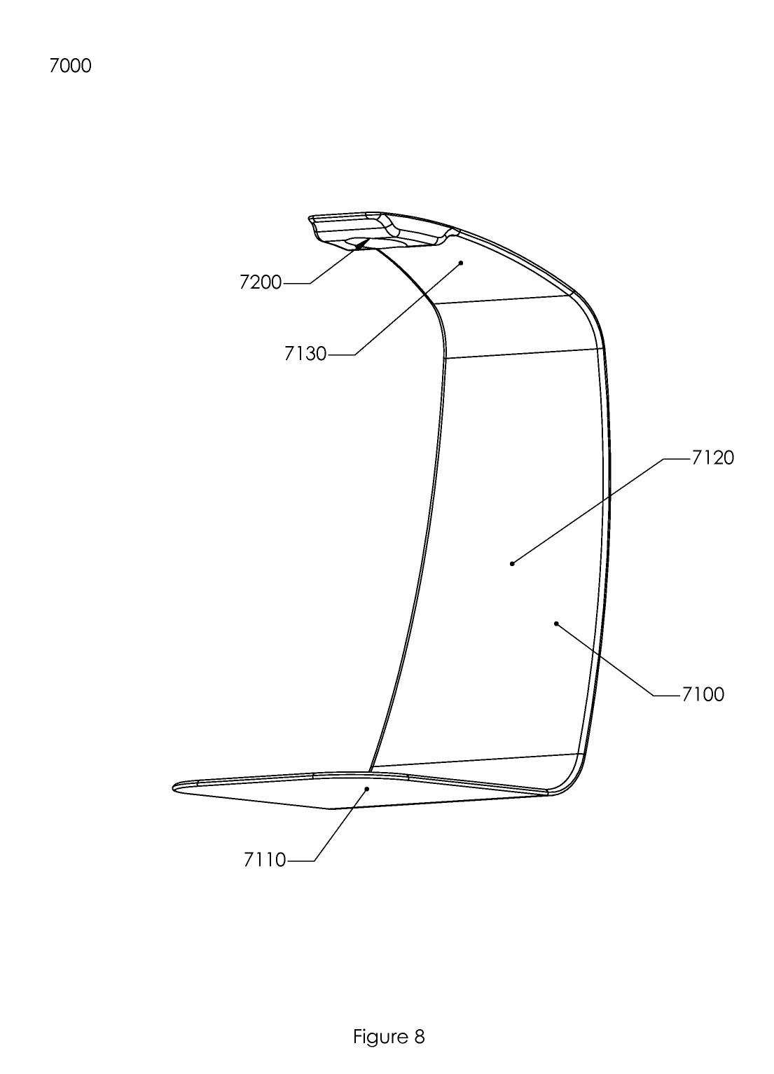

Referring now to FIG. 8, an embodiment of the present disclosure is shown. Rack 7000 comprises a body 7100 and a coupler 7200. Body 7100 is a curved member composed of a natural or synthetic polymer, metal, or laminations thereof approximating a c-shape with a foot portion 7110 at the ventral end thereof and a coupler 7200 at the dorsal end thereof. There is a magnet (not shown) disposed within coupler 7200 which is sized and shaped to magnetically retain the ferrous apex pin of a cap or other article thereagainst.

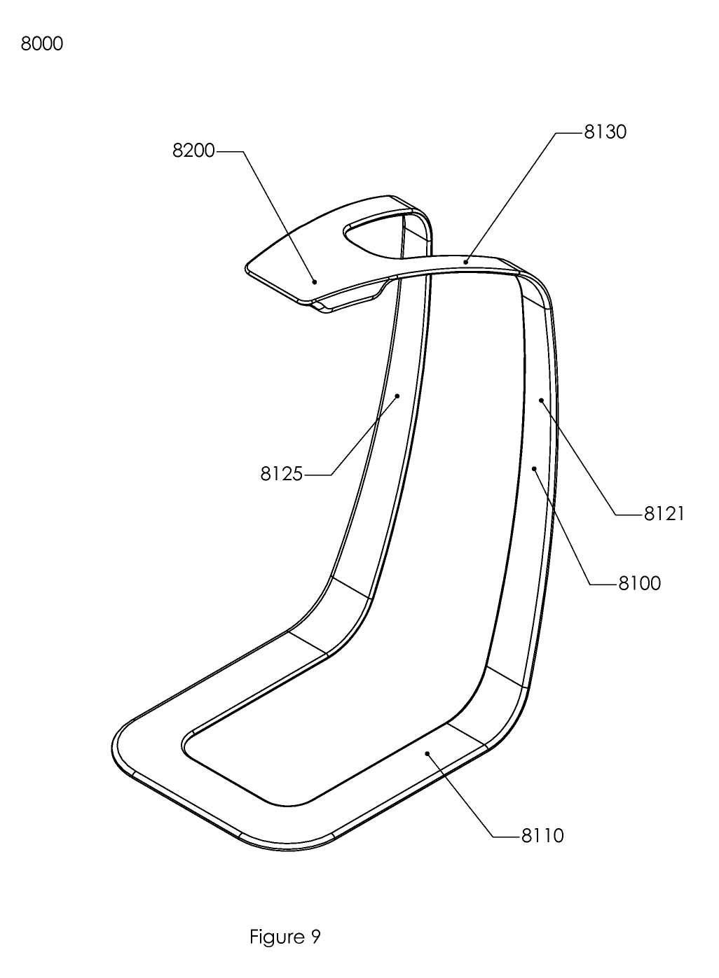

Referring now to FIG. 9, an embodiment of the present disclosure is shown. Rack 8000 comprises a body 8100 and a coupler 8200. Body 8100 is a curved member composed of a natural or synthetic polymer, metal, or laminations thereof approximating a c-shape with a foot portion 8110 at the ventral end thereof and a coupler 8200 at the dorsal end thereof. There is a portion removed from along the longitudinal axis of body 8100 thereby defining opposing arms 8121, 8125 and head 8130. There is a magnet (not shown) disposed within coupler 8200 which is sized and shaped to magnetically retain the ferrous apex pin of a cap or other article thereagainst.

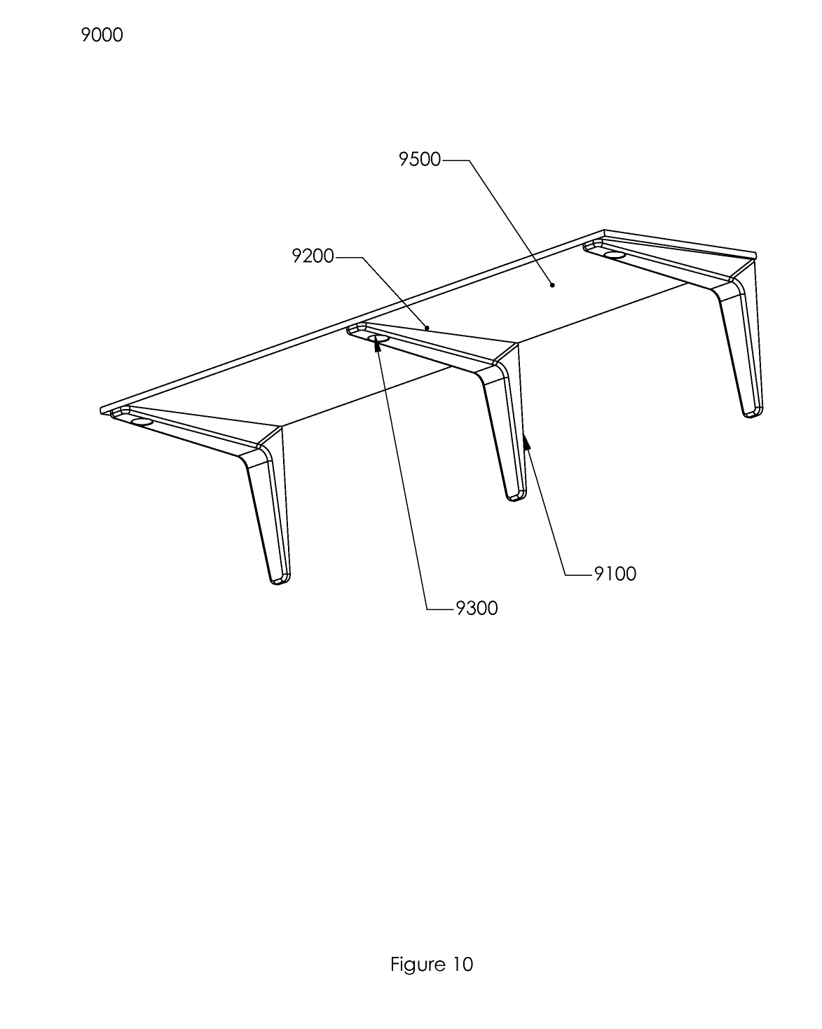

Referring now to FIG. 10, an embodiment of the present disclosure is shown. Rack 9000 comprises a right-angle bracket for supporting a shelf 9500 upon a dorsal face thereof, and a recessed magnet 9300 upon the ventral face thereof. Rack 9000 comprises an angled rigid member having a posterior face 9100 and a dorsal face 9200 at an orthogonal relation to one another.

A method of using the various embodiments will now be described. For instance, with reference to rack 1000, rack 1000 is provided in a first state, having no articles attached thereto. Next, an operator may use the rack by holding a ferrous object, including for instance the apex pin of a baseball cap, sufficiently close to hat coupler 1410 such that the magnetic attractive force between the hat coupler and the pin is sufficient to overcome gravitational force urging the hat to fall. Next, an operator removes their hand and the hat remains in place. When an operator wishes to separate the hat from the coupler 1410, he applies sufficient force thereto to overcome the magnetic attraction.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A display comprising;
a base portion having at least one contact point with a floor at a ventral end thereof and coupled to a beam at the dorsal end thereof;
the beam comprising an elongated, narrow, substantially vertical member coupled to a ventral-facing magnet at the dorsal end thereof;
the ventral-facing magnet sized and shaped to magnetically retain the ferrous pin disposed at the apex of a cap or other article thereagainst.

2. The display of claim 1, wherein there is a substantially planar member disposed between the beam and magnet, having substantially chiral, sloping sides at an obtuse angle to one another which opens ventrally with the sides meeting at a point at the dorsal apex thereof thereby allowing a garment to be hung thereon.

3. The display of claim 1, wherein the magnet is disposed at the dorsal apex of the inner circumference of a substantially planar annulus.

4. The display of claim 3, wherein there is a plurality of annulae in a substantially co-planar relation to one another.

5. The display of claim 1, wherein the magnet is disposed within a substantially annular projection which extends ventrally from the magnet and is sized and shaped to retain the apex pin of a cap therein.

6. The display of claim 1, wherein the magnet is disposed in a recess, the recess being sized and shaped to retain the apex pin of a cap therein.

7. A display comprising;
a body comprising a rigid volume having a posterior face and a ventral face, with the posterior face being substantially planar and operatively configured to be coupled to a stationary object, including for instance a wall;
a ventral-facing magnet disposed upon the ventral face of the body sized and shaped to magnetically retain the ferrous pin disposed at the apex of a cap or other article thereagainst.

8. The display of claim 7, wherein the body is coupled to a stationary object by one of the following; a bracket disposed on the body and mountable to the object, a bracket disposed on the object and mountable to the body, screws, nails, adhesive, snap fittings or other coupling means known in the arts.

9. The display of claim 7 wherein the body has substantially parallel ventral and dorsal faces, thereby defining a shelf.

10. The display of claim 7, wherein the magnet is disposed within a substantially annular projection which extends ventrally from the magnet and is sized and shaped to retain the apex pin of a cap therein.

11. The display of claim 7, wherein the magnet is disposed in a recess, the recess being sized and shaped to retain the apex pin of a cap therein.

12. The display of claim 7, wherein there is a plurality of magnets.

13. The display of claim 7, wherein the anterior face of the body has a portion of transparent polymer affixed thereto and operatively configured for retaining a tag therein.

13. The display of claim 7, wherein the body is an elongated member having a substantially C-shaped cross-section which opens posteriorly.

14. The display of claim 7, wherein the body is an elongated member having a substantially c-shaped cross-section which opens anteriorly.

15. A display comprising;
a folded, thin, rigid armature whose profile approximates a C-shape, the armature having a wide, substantially planar ventral end portion defining a foot, a substantially vertical portion defining a neck, and a substantially horizontal dorsal portion defining a head;
a ventral-facing magnet disposed upon the ventral face of the head sized and shaped to magnetically retain the ferrous pin disposed at the apex of a cap or other article thereagainst.

16. The display of claim 15, wherein there is a longitudinal portion removed from the foot, neck, and head, thereby defining a channel therethrough.

17. The display of claim 15, wherein the magnet is disposed within a substantially annular projection which extends ventrally from the magnet and is sized and shaped to retain the apex pin of a cap therein.

18. The display of claim 15, wherein the magnet is disposed in a recess, the recess being sized and shaped to retain the apex pin of a cap therein.

18. The display of claim 15, wherein there is a plurality of magnets.
